(19) United States
(12) Patent Application Publication
(10) Pub. No.: US 2004/0109278 A1
(43) Pub. Date: Jun. 10, 2004

(54) Transformer circuit

(75) Inventors: Andy Lee, Taipei (TW); Yu-Chiang Cheng, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: MITAC TECHNOLOGY CORP. and MITAC INTERNATIONAL CORP.

(21) Appl. No.: 10/313,789

(22) Filed: Dec. 6, 2002

(51) Int. Cl. H01H 47/00

(52) U.S. Cl. 361/143

(57) ABSTRACT

A transformer circuit for a power source having a first voltage level and a second voltage level. The first coil is coupled to the first voltage level at a terminal of the first coil to generate a first induced voltage by a first current. The demagnetization loop switch is coupled between another terminal of the first coil and the second voltage level to switch the first current according to a switching signal provided by an outside circuit. The demagnetization circuit is coupled between another terminal of the first coil and the first voltage level to consume the energy stored in the first coil when the demagnetization loop switch is turned off. The second coil is coupled to the second voltage level at a terminal of the second coil to generate a signal having a second induced voltage according to the first induced voltage.

### BACKGROUND OF THE INVENTION

1. Field of the Invention

The present invention relates in general to a transformer circuit. In particular, the present invention relates to a flyback transformer circuit that decreases electromagnetic interference (EMI).

2. Description of the Related Art

The flyback transformer is one of the most important elements of a computer monitor or television, serving to intensify the voltage of the TV picture tube. Presently, most monitors are connected to an outside power source. After a voltage of 110 Volts is input to the monitor, a transformer divides the voltage. A portion of the voltage is used as base voltage to drive the controlling IC for switching, and other voltage is transmitted to the flyback transformer. The voltage level received by the flyback transformer depends on the frequency of the horizontal scanning signal of the monitor. The flyback transformer generates the voltage from 25000 to 28000 volts. The high voltage heats the electronic gun of the TV picture tube to generate fluorescence, which is then projected to the screen.

FIG. 1 shows the circuit diagram of the conventional Flyback transformer. The alternating current (AC) provided by the outside power supply is transformed by a rectification circuit and a wave filter (not shown) to a direct current (DC). The DC signal is provided to a terminal 10A of the first coil 10 (main coil) of the transformer. Another terminal 10B of the first coil 10 is connected to a demagnetization loop switch 15, using an NMOS transistor as an example. In addition, the source of the demagnetization loop switch 15 is connected to the terminal 10B of the first coil 10, and the gate 15A of the demagnetization loop switch 15 receives the high frequency signal provided from an outer circuit, for example, the horizontal scanning signal of a monitor, and the drain of the demagnetization loop switch 15 is grounded. The high frequency switching of the voltage level of the signal provided from the outer circuit switches the demagnetization loop switch 15 on and off at a high frequency. The switching of the demagnetization loop switch 15 changes the current direction in the first coil 10. Thus, the magnetic flux in the first coil 10 is changed and generates magnetic field. The magnetic field is inducted by a second coil 12 of the transformer and generates a high frequency signal. The high frequency signal is rectified by an output diode 14 and an output capacitor 16 and is transformed to a direct current.

The design of the flyback transformer must avoid generating EMI, the electromagnetic noise generated by the electronic unit during operation or by the signal of the apparatus itself influencing the operation of other apparatus by radiation or conduction.

However, EMI is serious in the conventional flyback transformer, since the magnetic field of the first coil 10 cannot be induced to the second coil 12 completely. When the demagnetization loop switch 15 is turned off, the magnetic field remaining in the first coil 10 will influence the operation of other apparatus by radiation or conduction.

### SUMMARY OF THE INVENTION

The object of the present invention is to provide a transformer circuit having a demagnetization coil at the first coil. When the demagnetization loop switch is turned off, the demagnetization coil demagnetizes the magnetic field remaining in the first coil, such that demagnetization is achieved, and the EMI is decreased.

To achieve the above-mentioned object, the present invention provides a transformer circuit for a power source having a first voltage level and a second voltage level. The first coil is coupled to the first voltage level at a terminal of the first coil to generate a first induced voltage by a first current. The demagnetization loop switch is coupled between another terminal of the first coil and the second voltage level to switch the first current according to a switching signal provided by an outside circuit. The demagnetization circuit is coupled between another terminal of the first coil and the first voltage level to consume the energy stored in the first coil when the demagnetization loop switch is turned off. The second coil is coupled to the second voltage level at a terminal of the second coil to generate a signal having a second induced voltage according to the first induced voltage.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows the circuit diagram of a conventional Flyback transformer.

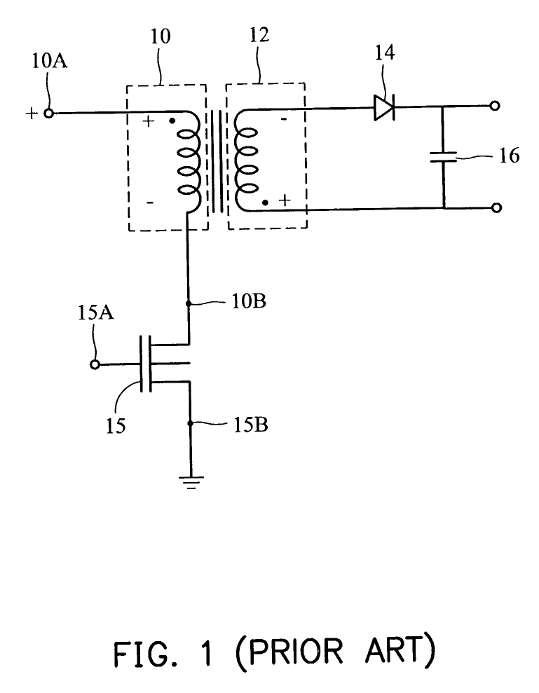

FIG. 2 shows the circuit diagram of the flyback transformer according to the embodiment of the present invention.

### DETAILED DESCRIPTION OF THE INVENTION

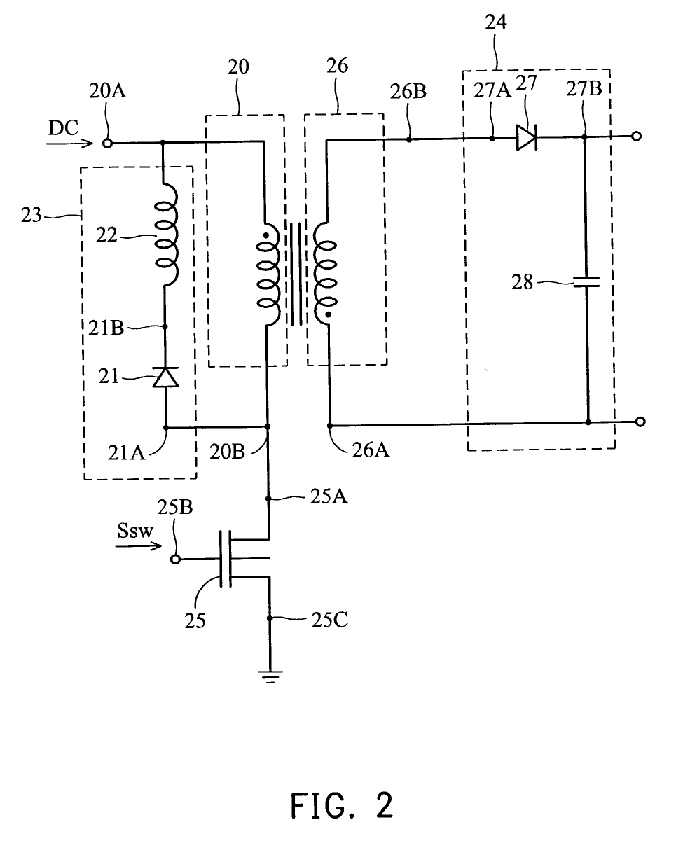

FIG. 2 shows the circuit diagram of the flyback transformer according to the embodiment of the present invention. The alternating current (AC) provided by the outside power supply is transformed by a rectification circuit and a wave filter (not shown) to a direct current (DC). The DC signal is provided to a terminal 20A of the first coil 20 of the flyback transformer.

Another terminal 20B of the first coil 20 is connected to a demagnetization loop switch 25, using an NMOS transistor for an example. In addition, the source 25A of the demagnetization loop switch 25 is connected to the terminal 20B of the first coil 20, the drain 25C of the demagnetization loop switch 25 is grounded, and the gate 25B of the demagnetization loop switch 25 receives the switching signal Ssw provided from the outer circuit, for example, the horizontal scanning signal of a monitor. The switching signal Ssw is a high frequency signal. The high frequency switching of the voltage level of the switching signal Ssw provided from the outer circuit switches the demagnetization loop switch 25 on and off at a high frequency. When switching signal Ssw is a high voltage level, the demagnetization loop switch 25 is turned on; when switching signal Ssw is a low voltage level, the demagnetization loop switch 25 is turned off.

The demagnetization circuit comprising a first diode 21 and a demagnetization coil 22 is coupled between the terminal 20B of the first coil 20 and the direct current source.

The first diode 21 comprises a positive terminal 21A and a negative terminal 21B. The positive terminal 21A is coupled to the terminal 20B of the first coil 20. Thus, the current only flows from the positive terminal 21A.

One terminal of the demagnetization coil 22 is coupled to the terminal 21B, and the other terminal is coupled to the terminal 20A of the first coil 20. The demagnetization coil 22 consumes the current output from the negative terminal 21B of the first diode 21. One terminal 26A of the second coil 26 is grounded to output the AC signal.

The rectification filter 24 comprises a second diode 27 and an output capacitor 28 to rectify and filter the AC signal output from the second coil 26 to DC signal.

The second diode 27 comprises a positive terminal 27A and a negative terminal 27B. The positive terminal 27A of the second diode 27 coupled to another terminal 26B of the second coil 26. The output capacitor 28 is coupled to the negative terminal 27B and the terminal 26A of the second coil 26.

When the demagnetization loop switch 25 is turned on, the direct current flows through the first coil 20 from terminal 20A. At this time, the current increases, so the induced voltage is generated at both sides of the first coil 20, wherein the voltage of the terminal 20A is higher than the terminal 20B. The energy stored in the first coil 20 is coupled to the second coil 26. Thus, the induced voltage is generated at both sides of the second coil 26, wherein the voltage of the terminal 26A is higher than the terminal 26B. In addition, the diode 21 resists the direct current flowing through the demagnetization coil 22 to avoid unnecessary power consumption.

When the demagnetization loop switch 25 is turned off, the direct current stops flowing through the first coil 20. At this time, the induced current flows from the terminal 26A of the second coil 26 to the terminal 26B, and charges the output capacitor 28 through the second diode 27. Thus, the energy stored in the output capacitor 28 is increased.

As mentioned above, the magnetic field of the first coil cannot be induced to the second coil completely. Thus, the energy remaining in the first coil is input to the demagnetization coil 22 through the first diode 21 from the positive terminal 21A. At this time, the demagnetization coil 22 consumes the input energy. Thus, the EMI is eliminated. The present embodiment uses the demagnetization coil 22 to reduce the energy stored in the first coil because the resistance of the demagnetization coil 22 is low when the signal is low frequency, thus, the efficiency of the transformer is not influenced. In addition, the resistance of the demagnetization coil 22 is high when the signal frequency is high. Thus, noise is eliminated effectively.

Accordingly, the transformer according to the embodiment of the present invention eliminates the energy remaining in the first coil. Thus, the EMI in the conventional transformer occurring when the demagnetization loop switch 25 is turned off is solved.

The foregoing description of the preferred embodiments of the invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A transformer circuit for a power source having a first voltage level and a second voltage level, comprising:
a first coil coupled to the first voltage level at a terminal of the first coil to generate a first induced voltage by a first current;
a demagnetization loop switch coupled between another terminal of the first coil and the second voltage level to switch the first current according to a switching signal provided by an outside circuit;
a demagnetization circuit coupled between another terminal of the first coil and the first voltage level to consume the energy stored in the first coil when the demagnetization loop switch is turned off; and
a second coil coupled to the second voltage level at a terminal of the second coil to generate a signal having a second induced voltage according to the first induced voltage.

2. The transformer circuit as claimed in claim 1, further comprising a rectification filter to rectify and filter the signal having the second induced voltage.

3. The transformer circuit as claimed in claim 1, wherein the demagnetization circuit comprises:
a first diode having a first positive terminal coupled to the another terminal of the first coil and a first negative terminal; and
a demagnetization coil coupled to the first negative terminal at a terminal of the demagnetization coil and coupled to the terminal of the first coil at another terminal of the demagnetization coil to consume the energy passing through the first diode.

4. The transformer circuit as claimed in claim 3, wherein the rectification filter comprises:
a second diode having a second positive terminal coupled to the another terminal of the second coil and a second negative terminal; and
a capacitor coupled to the second negative terminal and the terminal of the second coil.

5. The transformer circuit as claimed in claim 1, wherein the transformer circuit is a flyback transformer circuit.

6. The transformer circuit as claimed in claim 1, wherein the power source is direct current.

7. The transformer circuit as claimed in claim 1, wherein the demagnetization loop switch is an NMOS transistor.

8. The transformer circuit as claimed in claim 1, wherein the switching signal is a high frequency signal.

9. The transformer circuit as claimed in claim 1, wherein the switching signal is a horizontal scanning signal of a monitor.

10. The transformer circuit as claimed in claim 1, wherein the first voltage level is positive voltage level.

11. The transformer circuit as claimed in claim 1, wherein the second voltage level is ground voltage level.
